(19) United States
(12) Patent Application Publication
(10) Pub. No.: US 2017/0260957 A1
(43) Pub. Date: Sep. 14, 2017

(54) STARTER FOR A MOTOR VEHICLE THERMAL ENGINE, PROVIDED WITH A STOP

(71) Applicant: VALEO EQUIPEMENTS ELECTRIQUES MOTEUR, Creteil Cedex (FR)

(72) Inventors: Gauthier VIGY, Lyon (FR); Jean-François OEUVRARD, Lyon (FR); Jérémy BRANDINI, Bron (FR)

(21) Appl. No.: 15/521,840

(22) PCT Filed: Oct. 28, 2015
(86) PCT No.: PCT/EP2015/075021

§ 371 Date: Apr. 25, 2017

(30) Foreign Application Priority Data
Oct. 29, 2014 (FR) 1460409

(51) Int. Cl. F02N 15/06; F02N 15/02; F02N 11/00

(52) U.S. Cl. CPC F02N 15/065; F02N 11/00; F02N 15/025

(57) ABSTRACT

The invention relates mainly to a starter (10) for a heat engine of a motor vehicle, comprising: a drive pinion (12); a pinion carrier (63) whereon the drive pinion (12) is mounted; a drive shaft (13) whereon the pinion carrier (63) is mounted such that it can slide between an idle position and a final position; and a stop (68) that is constrained to rotate with the drive shaft (13) when the pinion carrier (13) presses against the stop (68) in the final position.

The invention relates to a starter for a motor vehicle thermal engine provided with an improved stop. The invention has a particularly advantageous application for vehicles which are equipped with the function of automatic stopping and restarting of the engine (so-called stop and start function).

In order to start a thermal engine, in particular of a motor vehicle, it is known to use a starter provided with a launcher which can transmit rotational energy of the starter to a starter crown of a thermal engine. This launcher is fitted such as to slide on a drive shaft, which is coupled to the shaft of an electric motor by means of a speed reducer. The launcher is mobile between a position of rest, in which the drive pinion is disengaged from the starter crown, and an active position in which a drive pinion is engaged with the starter crown, after activation of a contactor.

Document FR2978500 teaches the creation of a launcher comprising a drive pinion fitted integrally in rotation on a pinion-holder, a drive unit fitted on a drive shaft via a helical connection, and a friction clutch which is interposed between the pinion-holder and the drive unit.

The friction clutch comprises a pressure element belonging to the drive unit, a reaction element constituted by the plate of the pinion-holder, as well as friction discs which are situated between the pressure element and the reaction plate. The discs are alternately connected in rotation to the pinion-holder and to the drive unit. The clutch can go from an unlocked state, in which the drive unit and the pinion are uncoupled in rotation from one another, to a locked state in which the pinion and the drive unit are coupled in rotation to one another.

For this purpose, during the activation of the contactor of the starter, the mobile core is attracted by magnetic attraction in the direction of a fixed core, firstly in order to give rise to closure of the contacts of the contactor and supply power to the electric motor, and secondly to activate a control lever which acts on the launcher. The upper end of the lever is fitted in a known manner articulated on a mobile rod which is resiliently connected to the mobile core via a spring, known as a tooth-against-tooth spring, accommodated in the mobile core.

During its displacement, the control lever of the starter displaces the launcher axially in the direction of the starter crown along the drive shaft. During this step, the clutch is unlocked, such that the pinion is free to rotate relative to the drive unit in both directions of rotation. With the axial movement continuing, the pinion reaches the vicinity of the starter crown. The pinion which is free in rotation penetrates slightly into the crown.

The lever in contact then displaces axially the pressure element of the drive unit in the direction of the reaction plate, such that the gap between the discs is eliminated. The clutch then goes from the unlocked state to the locked state, because of the clamping force derived from the force applied by the control lever on the drive unit, and the reaction force applied by an axial stop against which the pinion-holder is supported.

In order to keep the clutch in the locked state, in particular during expansion passages of the engine which intermittently generate excess speeds of the pinion which can give rise to opening of the clutch, it is necessary to provide a negative gap in the chain of dimensions going from the contactor to the stop against which the pinion-holder is supported. This negative gap leads to compression of a few millimetres of the tooth-against-tooth spring during the locking of the clutch.

However, taking into account the wear by friction of the different elements involved in the locking of the clutch, this negative gap is difficult to maintain in the long term, in particular for starters which are subjected to a very high number of operating cycles, such as those which equip vehicles provided with the stop and start function.

More specifically, it has been noticed that axial stops which use an inner circlip for their retention generate a machining effect on the drive shaft. This machining effect is caused by the contact surfaces which are not smooth, as well as by the relative displacement in rotation of the circlip in comparison with the drive shaft. Since the negative gap is rapidly lost because of this machining effect, closure of the clutch is then no longer guaranteed during passage of the launcher to the active position.

In addition, for a starter comprising a free wheel, when the pinion comes into contact against the stop for a large number of cycles, in particular by contact erosion, the stop, the portion of the shaft in contact with the stop, and the pinion, are worn, and can give rise to breakage by coming into contact with the arch.

The objective of the invention is to eliminate this disadvantage efficiently by proposing a starter for a motor vehicle thermal engine comprising:
a drive pinion;
a pinion-holder on which the said drive pinion is fitted;
a drive shaft on which the said pinion-holder is fitted such as to slide between a position of rest and a final position; and
a stop which is integral in rotation with the said drive shaft when the said pinion-holder is supported against the said stop in the final position, and the said pinion-holder can rotate at a speed of rotation different from that of the drive shaft.

Taking into account the connection in rotation of the stop to the drive shaft when the pinion-holder is in the final position, the invention makes it possible to control the wear of the stop by ensuring that the wear will be localised in the area of contact between the pinion-holder and the stop. The invention also makes it possible to ensure that the wear which occurs at the stop is derived from the contact between smooth outer surfaces of these two elements.

According to one embodiment, the said stop comprises a stop ring, the said stop ring being in contact with an end of the said pinion-holder in the final position, and a device for connection in rotation of the said stop ring to the said drive shaft.

According to one embodiment, the said drive shaft comprises a means for axial retention of the said device for connection in rotation.

According to one embodiment, the said means for axial retention is constituted by a shoulder which cooperates with a groove provided in the said device for connection in rotation.

According to one embodiment, the said means for axial retention is constituted by a groove which cooperates with a shoulder of the said device for connection in rotation.

According to one embodiment, the said starter comprises a device for axial retention of the stop ring cooperating with the said device for connection in rotation.

According to one embodiment, the said device for axial retention is a circlip which is fitted in an inner periphery of the said stop ring, the said circlip being in axial abutment against the said device for connection in rotation.

According to one embodiment, the said stop is free in rotation with the said drive shaft when the said pinion-holder is in the position of rest.

According to one embodiment, the said device for connection in rotation comprises two half shells, each having an outer face in the form of a portion of a cone cooperating with a conical inner face with a complementary form of the said stop ring. A configuration of this type makes it possible to transform an axial force of the pinion-holder on the stop ring into a radial clamping force of the half shells on the drive shaft.

According to one embodiment, the said half shells are situated spaced from one another when the said pinion-holder is in the position of rest.

According to one embodiment, the said stop is integral in rotation with the said drive shaft irrespective of the position of the said pinion-holder.

According to one embodiment, the said device for connection in rotation comprises at least one flattened part which cooperates with a flattened part provided in the said drive shaft, and at least one flattened part which cooperates with a flattened part of the said stop ring.

According to one embodiment, the said device for connection in rotation is in the form of a “U”.

According to one embodiment, the said drive shaft comprises a number of flattened parts which can cooperate with the at least one flattened part of the said device for connection in rotation which is larger than the number of flattened parts of the said device for connection in rotation which can cooperate with the said drive shaft. This makes it possible to facilitate the indexing of the device for connection in rotation on the drive shaft.

According to one embodiment, the said device for connection in rotation comprises a ring made of a deformable material fitted clamped between the said drive shaft and the said stop ring, the said deformable ring cooperating with grooves provided in an outer periphery of the said drive shaft.

According to one embodiment, a circlip which forms a stop is also fitted in an annular groove provided in an outer periphery of the said drive shaft.

The invention will be better understood by reading the following description and examining the figures which accompany it. These figures are given purely by way of illustration and in no way limit the invention.

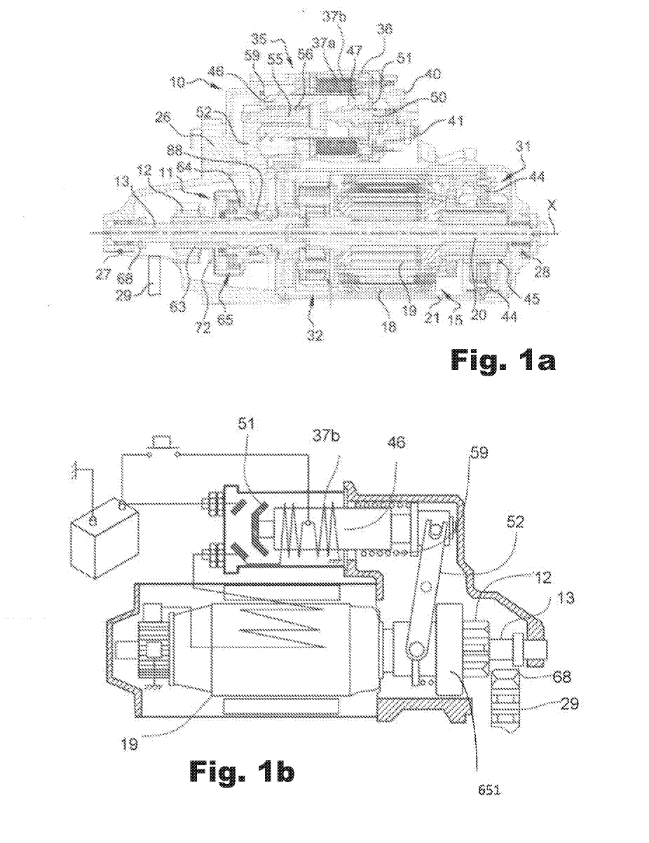

FIG. 1a is a view in longitudinal cross-section of an example of a starter for a motor vehicle thermal engine according to the present invention;

FIG. 1b represents a skeleton diagram of a starter according to another example of the present invention;

FIG. 2 is a view in longitudinal cross-section of the launcher of the starter in FIG. 1a;

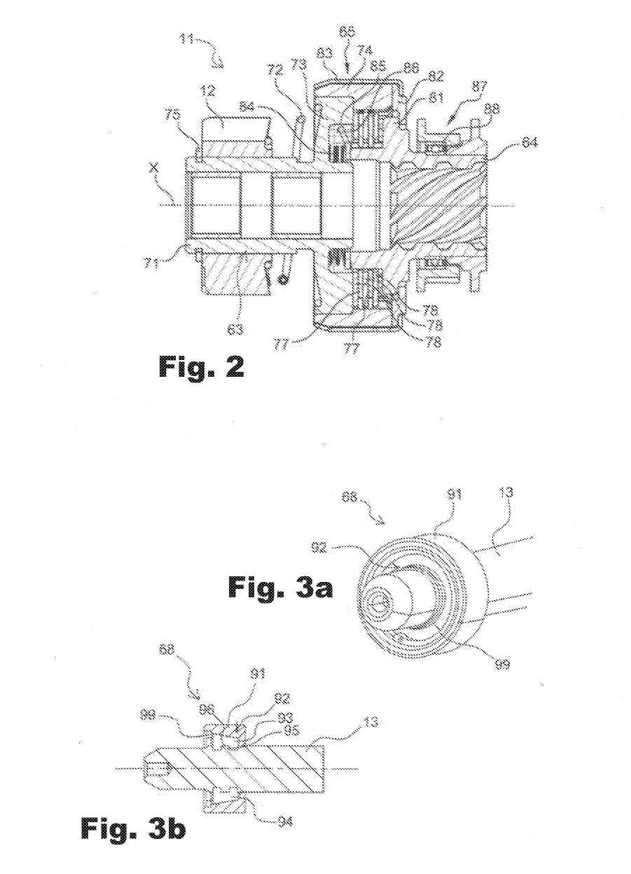

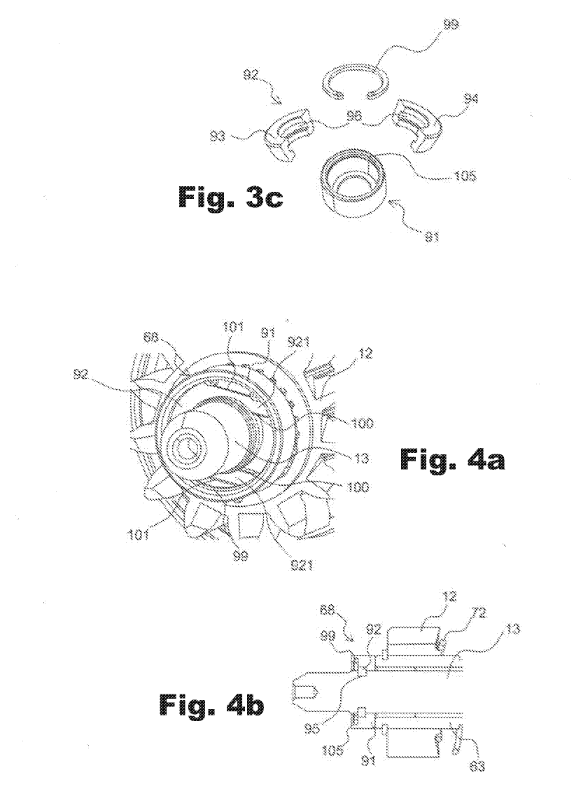

FIGS. 3a and 3b are respectively views in perspective and in longitudinal cross-section illustrating a first embodiment of the axial stop according to the present invention fitted on the drive shaft;

FIG. 3c is an exploded view in perspective of the axial stop of FIGS. 3a and 3b without the drive shaft;

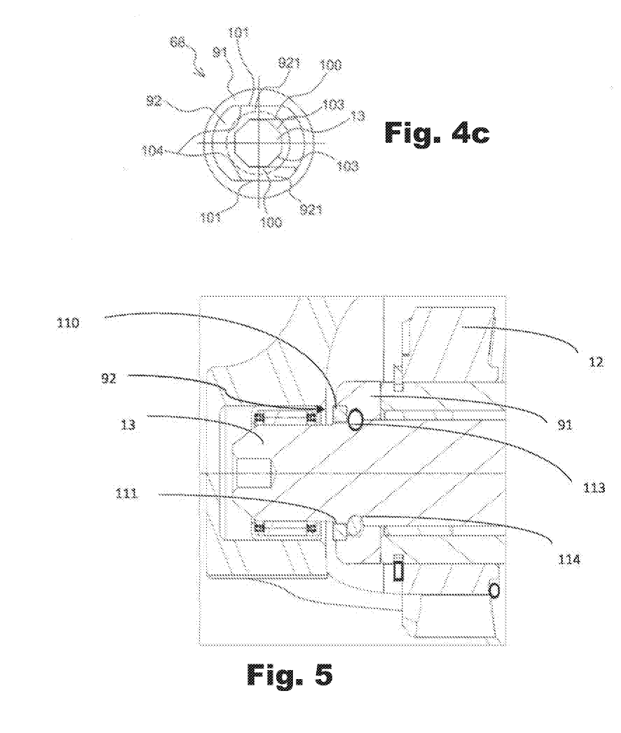

FIGS. 4a, 4b and 4c are respectively views in perspective, in longitudinal cross-section and in transverse cross-section, illustrating a second embodiment of the axial stop according to the present invention;

FIG. 5 is a view in longitudinal cross-section illustrating a third embodiment of the axial stop according to the present invention;

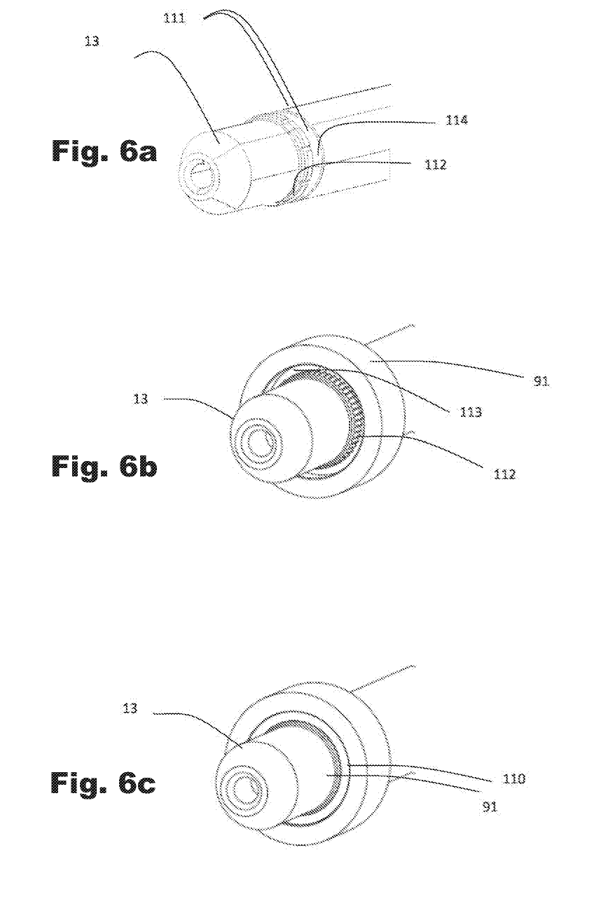

FIGS. 6a to 6c are views in perspective illustrating the different steps of assembly for production of the axial stop in FIG. 5.

Elements which are identical, similar or analogous retain the same reference from one figure to another.

Hereinafter in the description, an orientation from front to rear corresponds to an orientation from left to right in FIGS. 1a, 1b and 2. Thus, a front face of an element is the face which faces towards the front bearing 27, and the rear face is the face which faces towards the rear bearing 28 of the starter.

With reference to FIG. 1a, the starter 10 according to the invention comprises a friction launcher 11 provided with a drive pinion 12 which is fitted such as to be mobile in translation on a drive shaft 13, and an electric motor 15 constituted by a stator 18 and an armature rotor 19 integral with a shaft 20. The motor 15 comprises a head 21 which is fitted on a support 26 of the starter 10 designed to be secured on a fixed part of the motor vehicle.

The launcher 11 can go from a position of rest (the one in FIG. 1a), in which the drive pinion 12 is disengaged from a starter crown 29 of a thermal engine, to an active position (not represented) in which the drive pinion 12 is engaged with the starter crown 29, and vice versa.

The drive shaft 13 has its front end fitted such as to be mobile in rotation in the front bearing 27 by means of a roller bearing. The shaft 20 of the motor 15 has its rear end fitted in a roller bearing of the rear bearing 28, with which a brush-holder 31 is integral.

A speed reducer 32 with gears of the epicycloidal train type is preferably interposed between a rear end of the drive shaft 13 and a front end of the shaft 20 of the electric motor 15.

The starter 10 also comprises an electromagnetic contactor 35 which extends parallel to the electric motor 15, whilst being implanted radially above the latter. The contactor 35 has a metal vessel 36 equipped with a set of excitation coils 37a, 37b. Terminals 40, 41 are formed such as each to establish a fixed contact inside the vessel 36. One of the terminals 40 is designed to be connected to the positive terminal of the vehicle battery. The other terminal 41 is connected to the input of the inductor winding of the stator 18, and to the brushes 44 with positive polarities, as explained in greater detail hereinafter.

These brushes 44 rub on conductive strips 45 of a collector, in order to supply the rotor winding with power. The brushes 44 belong to the brush-holder 31 equipped with cages for guiding and receipt of the brushes 44. These brushes 44 are thrust in the direction of the conductive strips 45 by resilient means of the spring type.

During the excitation of the pull-in coil 37a, a mobile core 46 is attracted by magnetic attraction in the direction of a fixed core 47 of the contactor 35, firstly in order to act after elimination of play on a control rod 50 which supports a mobile contact plate 51, in order to give rise to closure of the contacts 40, 41 of the contactor 35 and supply the electric motor 15 with power, and secondly in order to activate a control lever 52 which acts on the launcher 11. The upper end of the lever 52 is fitted in a known manner articulated on a mobile rod 55, which is connected resiliently to the mobile core 46 via a spring 56, known as the tooth-against-tooth spring, accommodated in the mobile core 46.

This tooth-against-tooth spring 56 is compressed when the contact plate 51 is displaced towards the terminals 40, 41, and the pinion 12 is blocked in translation by the teeth of the starter crown 29. This blocked state is known as the “tooth-against-tooth position”. The tooth-against-tooth spring 56 is also slightly compressed when the clutch 65 is in a locked state, as explained hereinafter.

The contactor 35 additionally comprises a return spring 59 which is supported on the fixed coils 37a, 37b and the mobile core 46, in order to thrust it forwards as far as its position of rest, and simultaneously displace the control lever 52 until the launcher 11 returns to the position of rest.

As can be seen clearly in FIG. 2, the friction launcher 11 comprises the drive pinion 12, which is fitted such as to slide on a pinion-holder 63, a drive unit 64 which is activated by the control lever 52, and a friction clutch 65 which is interposed axially between the drive unit 64 and the pinion-holder 63.

The drive unit 64 is provided in its interior with helical ribbing engaged in a complementary manner with outer helical toothing supported by the drive shaft 13. The launcher 11 is thus driven with helical movement when it is displaced by the lever 52 against the axial stop 68, in order, by means of the pinion 12, to be engaged with the starter crown 29 in the active position.

More specifically, the pinion-holder 63 comprises a sleeve 71 with axial orientation, with a bore for its fitting on the drive shaft 13. In order to permit axial displacement of the drive pinion 12 relative to the sleeve 71, whilst having coupling in rotation of these two elements, ribbing provided in the outer periphery of the sleeve 71 cooperates with complementary ribbing provided in the inner periphery of the drive pinion 12.

The pinion-holder 63 also comprises a plate 73 with transverse orientation, which is situated in the extension of a rear end of the sleeve 71. This plate 73 is itself extended on its outer periphery by an annular skirt 74 with axial orientation. This skirt 74 faces towards the rear in the direction of the drive unit 64.

In addition, a spring 72 which in this case has a frusto-conical helical form, is supported at one of its ends against a rear face of the pinion 12, and at the other one of its ends on the front face of the plate 73. In the position of rest of the launcher 11, the spring 72 thrusts the pinion 12 in the direction of a stop 75 constituted for example by a circlip. When the pinion 12 abuts the crown and does not penetrate into it, the spring 72 is compressed and the pinion 12 withdraws in the direction of the plate 73. Two bearing bushes 76 are interposed between the smooth section of the drive shaft 13 and the sleeve 71.

The friction clutch 65 comprises a reaction element constituted by the plate 73 of the pinion-holder 63, a pressure element 81 constituted by a shoulder of the drive unit 64, as well as friction discs 77, 78, which are situated between the pressure element 81 and the reaction plate 73.

The clutch 65 can go from an unlocked state, in which the drive unit 64 and the pinion-holder 63 are uncoupled in rotation relative to one another, to a locked state in which the pinion-holder 63 and the drive unit 64 are coupled in rotation to one another because of pressing of the discs 77, 78 against one another by application of a clamping force between the pressure element 81 and the reaction plate 73, and vice versa.

For this purpose, the drive unit 64 is mobile in translation relative to the reaction plate 73 within the limit of an axial gap, between an uncoupled position corresponding to the unlocked state of the clutch 65, and a coupled position corresponding to the locked state of the clutch 65. In addition, the pinion-holder 63 is mobile in translation on the drive shaft 13, between a position of rest, in which the pinion-holder 63 is spaced from the axial stop 68, and a final position in which the pinion-holder 63 is supported against the axial stop 68, in order to allow the generation of the clamping force on the clutch 65, for its retention in the locked state.

The discs 77, 78 are accommodated in a casing delimited by the reaction plate 73 connected to the pinion-holder 63, the annular skirt 74 connected to the outer periphery of the reaction plate 73, as well as by a closure ring 82. In addition, the ring 82 is hollow in an annular manner on its outer periphery for fitting of a cover 83 for assembly of the ring 82 on the pinion-holder 63.

The discs 77, 78 are alternately connected in rotation to the pinion-holder 63 and to the drive unit 64. For this purpose, first discs, known as inner discs 77, comprise on their inner periphery a plurality of lugs inserted inside corresponding notches situated in the outer periphery of the drive unit 64. Second discs, known as outer discs 78, comprise on their outer periphery a plurality of lugs inserted inside corresponding notches situated in the inner periphery of the annular skirt 74. The inner discs 77 are thus connected in rotation to the drive unit 64, and the outer discs 78 are connected in rotation to the drive pinion 12. The discs 77, 78 can slide axially by means of notches and their corresponding lugs.

The launcher 11 can also comprise a resilient means 84 which is for example in the form of a spring washer, positioned inside a channel 85 in the pinion-holder 63. The spring washer 84 is fitted compressed between the base of the channel 85 and a retention washer 86, supported on the end of the drive unit 64, in order to facilitate the separation of the drive unit 64 from the reaction plate 73, when the clutch 65 goes to the unlocked state. The spring washer 84 is thus protected against wear by the retention washer 86 which is connected in rotation to the reaction plate 73.

In addition, the control unit 52, which is fitted with pivoting connection relative to the support 26, comprises an upper part which is coupled mechanically to the contactor 35, and a lower part comprising two branches in the form of a fork fitted in a channel 87 of the drive unit 64. An intermediate element 88 for reduction of friction is fitted between the control lever 52 and the drive unit 64. Thus, this configuration makes it possible to dissociate the function of thrusting of the lever 52 from the rotation of the drive unit 64, which makes it possible to reduce greatly or even eliminate the friction between the lever 52 and the drive unit 64, during a phase of locking of the clutch 65. The intermediate element 88 is constituted for example by a ball bearing.

FIG. 1b represents a skeleton diagram of a starter according to a second example of the invention. In this second example, the pinion 12 is fitted integrally on a pinion-holder comprising a track formed on the outer circumference of the pinion-holder, known as the output track, of a free wheel 651, making it possible to connect the pinion to the drive shaft 130 in a single direction of rotation. Thus, this second example of a starter replaces the friction clutch 65 previously described by a free wheel 651. Free wheels of this type are known in the prior art. In this second example, the pinion-holder and the pinion are integral. More specifically, the pinion-holder 63 comprises a sleeve 71 with axial orientation with a bore for its fitting on the drive shaft 13. The pinion then comprises teeth which extend radially, regularly distributed circumferentially, from the outer surface of the sleeve 71.

According to a third example, not represented, the pinion comprises teeth as well as a hollow shaft, and the pinion is fitted such as to slide on the pinion-holder. In this example, a spring 72 is fitted between the pinion and the pinion-holder, in order to force the pinion to go towards the stop 68. In the same way as in the first example, a stop 75 is fitted on the pinion-holder, in order to stop the pinion. In order to permit axial displacement of the drive pinion 12 relative to the sleeve 71, whilst having coupling in rotation of these two elements, in a manner identical to the first example, ribbing provided in the outer periphery of the sleeve 71 cooperates with complementary ribbing provided in the inner periphery of the drive pinion 12.

In these second and third examples, the drive unit 64 is provided with an input track (not represented, but well known in the prior art), provided in an inner circumference, of the drive unit, this input track comprising ramps. Rollers and springs are provided between the output track of the pinion-holder, and the input track of the drive unit.

Thus, in the second and third examples, during operation when the engine has started, the starter crown 29 turns faster than the drive shaft, and the pinion goes into free wheel mode, i.e. the free wheel allows the pinion, and thus the pinion-holder, to rotate faster than the drive shaft.

In these second and third examples, in a manner identical to the first example, the drive unit 64 is provided in its interior with helical ribbing engaged in a complementary manner with outer helical toothing supported by the drive shaft 13. The launcher is thus driven with helical movement when it is displaced by the lever 52 against the axial stop 68, in order to be engaged by means of the pinion 12 with the starter crown 29 in the active position.

FIGS. 3a-3c and 4a-4c show respectively two embodiments of an axial stop 68 which is integral in rotation with the drive shaft 13 when the pinion-holder 63 is supported against the stop 68 in the final position. These two embodiments are adaptable for the three embodiments.

In all cases, the stop 68 comprises a stop ring 91 which is in contact with the front end of the pinion-holder 63, when the latter is in the final position, as well as a device 92 for connection in rotation, ensuring a connection in rotation of the stop ring 91 with the drive shaft 13.

In the embodiment in FIGS. 3a to 3c, the device 92 for connection in rotation comprises two half shells 93, 94 in the form of a portion of ring, situated on both sides of the drive shaft 13. These half shells 93, 94 each have an outer face in the form of a portion of cone cooperating with a conical inner face with a complementary form of the stop ring 91. The half shells 93, 94 are situated spaced from one another, i.e. a space exists between the ends of the half shells 93, 94, when the pinion-holder 63 is in the position of rest.

Thus, the stop 68 is free in rotation with the drive shaft 13, when the pinion-holder 63 is in the position of rest. When the pinion-holder 63 goes into the final position, the axial force generated by the pinion-holder 63 against a rear face of the stop ring 91 is transformed into a force with radial components which are opposite one another, because of the conical configuration of the surfaces of contact between the stop ring 91 and the half shells 93, 94. This makes it possible to ensure the gripping of the half shells 93, 94 on the drive shaft 13, such that the stop 68 is then integral in rotation with the drive shaft 13.

Preferably, the drive shaft 13 additionally comprises a means 95 for axial retention of the half shells 93, 94. As shown in FIG. 3b, the means 95 for axial retention is constituted by a radial shoulder cooperating with a groove 96 provided in the device 92 for connection in rotation. In this case, the groove 96 is formed in the inner periphery of each half shell 93, 94. Alternatively, the means 95 for axial retention is constituted by a groove cooperating with a shoulder of the device 92 for connection in rotation.

The stop 68 also preferably comprises a device 99 for axial retention of the stop ring 91, cooperating with the device 92 for connection in rotation. The device 99 for axial retention is in this case a circlip fitted in an annular channel 105 provided in an inner periphery of the stop ring 91 (cf. FIG. 3c). This circlip 99 is in axial abutment against the half shells 93, 94.

In the embodiment in FIGS. 4a to 4c, the device 92 for connection in rotation comprises at least one flattened part 100 cooperating with a flattened part provided in the drive shaft 13, and at least one flattened part 101 cooperating with a flattened part of the stop ring 91.

As can be seen clearly in FIGS. 4a and 4c, the device 92 for connection in rotation is in this case constituted by a part in the form of a “U” in which the inner edges of the two branches 921 of the “U”, i.e. the edges which face towards the shaft 13, each have a flattened part 100 cooperating with a corresponding flattened part 103 provided in an outer periphery of the drive shaft 13. In addition, the outer edges of the two branches of the “U”, i.e. the edges which face on the side opposite the shaft 13, each have a flattened part 101 which cooperates with a corresponding flattened part 104 provided in an inner periphery of the stop ring 91.

Advantageously, the drive shaft 13 comprises more flattened parts 103 than the number of flattened parts 100 of the device 92 for connection in rotation which can cooperate with the drive shaft 13. This makes it possible to facilitate the indexing of the device 92 for connection in rotation on the drive shaft 13. Thus, in the case when the device 92 for connection in rotation in the form of a “U” has two diametrically opposite flattened parts 100, the drive shaft 13 will be able to comprise eight corresponding flattened parts 103, as can be seen in FIG. 4c. The stop ring 91 comprises a number of flattened parts 104 equal to the number of flattened parts 101 of the device 92, i.e. two flattened parts.

The drive shaft 13 additionally comprises a means 95 for axial retention of the device 92 for connection in rotation. As shown in FIG. 4b, the means 95 for axial retention is a groove which cooperates with the branches of the device 92 for connection in rotation.

The stop 68 also preferably comprises a device 99 for axial retention of the stop ring 91 cooperating with the device 92 for connection in rotation. In this case, the device 99 for axial retention is a circlip fitted in the groove 105 provided in an inner periphery of the stop ring 91. This circlip 99 abuts axially the device 92 for connection in rotation in the form of a “U”.

In the embodiment in FIGS. 4a to 4c, it should be noted that the stop 68 is integral in rotation with the drive shaft 13, irrespective of the position of the pinion-holder 63.

In the embodiment in FIG. 5, the device 92 for connection in rotation comprises a ring 110 made of a deformable material. This ring 110 is fitted clamped between the drive shaft 13 and the stop ring 91. This deformable ring 110 can be made of any suitable deformable material, and preferably of plastic such as nylon, polyurethane, or of soft metal.

The ring 110 cooperates with grooves 111 provided in an outer periphery of a shoulder 112 of the drive shaft 13.

In addition, in order to ensure axial retention of the assembly during an impact with the pinion-holder 63, a circlip 113 which forms a stop is fitted in an annular channel 114 provided in an outer periphery of the shaft 13, and cooperates with a corresponding channel provided in the stop ring 91.

During production, in a first step the grooves 111 are formed in the shoulder of the shaft 13, as illustrated in FIG. 6a, then the circlip 113 and the stop ring 91 are fitted on the shaft 13 (cf. FIG. 6b).

Finally, the deformable ring 110 is fitted clamped within an inner periphery, such that the deformable ring 110 adopts the form of the grooves 111, which has the effect of ensuring a connection in rotation of the stop ring 91 with the shaft 13. As a variant, the fitting could be inverted, provided that there is inversion of the positioning on the shaft 13 of the shoulder 112 and the groove 114.

The advantage of an embodiment of this type is that its cost is reduced because of the use of a deformable ring 110 made of plastic material. In addition, the modifications to be made on the assembly line are relatively limited, taking into account the small number of steps to be added in comparison with the conventional method for assembly of the stop 68.

A description is provided hereinafter of the functioning of the first example of the starter 10 according to the invention, when the launcher goes from the position of rest to the active position.

In the position of rest, the drive unit 64 is in the uncoupled position, the discs 77, 78 are not clamped, such that an axial gap exists distributed between the pressure element 81, the inner 77 and outer 78 discs, and the reaction plate 73. The pinion-holder 63 is in a position of rest in which the pinion-holder 63 is spaced from the axial stop 68.

With the contactor 35 being supplied electrically, the mobile core 46 is attracted towards the fixed core 47 in the direction of the magnetised position. Its displacement simultaneously drives the mobile rod 55, the mobile contact plate 51 and the control rod 50 rearwards. The lever 52 displaced by the mobile rod 55 then acts in a first step on the ring 82 of the casing, such as to displace the pinion-holder 63 and the pinion 12 axially in the direction of the crown along the drive shaft 13. During this step, the drive unit 64 is in the uncoupled position, such that the pinion 12 is free in rotation in both directions of rotation. With the axial movement continuing, the pinion 12 reaches the vicinity of the crown.

In a second step, the pinion 12 which is free in rotation penetrates slightly into the crown. During this second step, the displacement of the mobile core 46 is such that the mobile contact plate 51 establishes a contact between the two terminals 40, 41 in order to supply the electric motor 15.

With the electric motor 15 being supplied with power, the rotation of the drive shaft 13 drives the drive unit 64 towards the reaction plate 73 in the direction of the coupled position, such that the gap between the discs 77, 78 is progressively eliminated. In addition, in its final position, the pinion-holder 63 is supported against the axial stop 68. In the case of the embodiment in FIGS. 3a to 3c, the axial force applied by the pinion-holder 63 to the stop ring 91 of the stop 68 is transformed into a force of radial gripping of the half shells 93, 94 on the drive shaft 13. The stop 68 is then held integrally in rotation with the drive shaft 13.

With a clamping force being applied to the clutch 65 because of the action of the lever 52 on the launcher 11, and the resulting force applied by the stop 68 against which the pinion-holder 63 is supported, the clutch 65 is in the locked state. Torque can then be transmitted from the drive pinion 12 to the starter crown 29.

When the starter crown 29 rotates faster than the drive shaft 13 which supports the drive pinion 12, the friction clutch 65 is released, since the drive unit 64 performs an axial movement rearwards because of the helical connection between the drive unit 64 and the shaft 13. The drive unit 64 is unscrewed in order to go from the coupled position to the uncoupled position. This action is amplified by the spring washer 84, which expands and thrusts the drive unit 64 rearwards via the retention washer. In addition, the action of the lever 52 and the return spring 59 makes the launcher 11 go from the active position to the position of rest.

A description is provided hereinafter of the functioning of the second and third examples of the starter 10 according to the invention, when the launcher goes from its position of rest to the active position.

In the position of rest, the pinion-holder 63 is thus in a position of rest, in which the pinion-holder 63 is spaced from the axial stop 68.

With the contactor 35 being supplied electrically, the mobile core 46 is attracted towards the fixed core 47 in the direction of the magnetised position. Its displacement drives the mobile rod 55, the mobile contact plate 51 and the control rod 50 simultaneously rearwards. The lever 52 displaced by the mobile rod 55 then acts in a first step on the ring 82 of the casing, such as to displace the pinion-holder 63 and the pinion 12 axially in the direction of the crown along the drive shaft 13. During this step, the drive unit because of the helical grooves, and the pinion-holder and the pinion by means of the free wheel, rotate whilst advancing towards the stop 68.

With the axial movement continuing, the pinion 12 reaches the vicinity of the crown.

In a second step, the pinion 12 penetrates slightly into the crown, or is tooth-against-tooth against the crown. During this second step, the displacement of the mobile core 46 is such that the mobile contact plate 51 establishes a contact between the two terminals 40, 41, in order to supply the electric motor 15 with power.

With the electric motor 15 being supplied with power, the rotation of the drive shaft 13 rotates the drive unit 64, and thus the pinion, in order to engage in the crown.

In the case of the embodiment in FIGS. 3a to 3c, the axial force applied by the pinion-holder 63 on the stop ring 91 of the stop 68 is transformed into a force of radial gripping of the half shells 93, 94 on the drive shaft 13. The stop 68 is then held integrally in rotation with the drive shaft 13.

Torque can then be transmitted from the drive pinion 12 to the starter crown 29.

When the starter crown 29 rotates faster than the drive shaft 13 which supports the drive pinion 12, the free wheel is activated, and the drive unit is uncoupled in rotation from the pinion-holder. The stop 68 connected in rotation to the drive shaft means that, because of the difference of speed between the pinion-holder and the drive shaft, the two wear surfaces are formed between a surface of the stop and the pinion. These two surfaces have the advantage of having a larger support surface, and therefore of becoming worn less quickly than in the prior art.

It will be appreciated that the preceding description has been provided purely by way of example, and does not limit the field of the present invention, a departure from which would not be constituted by replacement of the different elements by any other equivalents.

1. Starter (10) for a motor vehicle thermal engine comprising:
a drive pinion (12);
a pinion-holder (63) on which said drive pinion (12) is fitted;
a drive shaft (13) on which said pinion-holder (63) is fitted such as to slide between a position of rest and a final position; and
a stop (68) which is integral in rotation with said drive shaft (13) when said pinion-holder (13) is supported against said stop (68) in the final position, and said pinion-holder can rotate at a speed of rotation different from that of the drive shaft.

2. Starter according to claim 1, wherein said stop (68) comprises a stop ring (91), said stop ring (91) being in contact with an end of said pinion-holder (63) in the final position, and a device (92) for connection in rotation of said stop ring (91) to said drive shaft (13).

3. Starter according to claim 1, wherein said drive shaft (13) comprises a means (95) for axial retention of said device (92) for connection in rotation.

4. Starter according to claim 3, wherein said means (95) for axial retention is constituted by a shoulder which cooperates with a groove provided in said device (92) for connection in rotation.

5. Starter according to claim 3, wherein said means (95) for axial retention is constituted by a groove which cooperates with a shoulder of said device (92) for connection in rotation.

6. Starter according to claim 2, wherein said starter comprises a device (99) for axial retention of the stop ring cooperating with said device (92) for connection in rotation.

7. Starter according to claim 6, wherein said device (99) for axial retention is a circlip which is fitted in an inner periphery of said stop ring (91), said circlip being in axial abutment against said device (92) for connection in rotation.

8. Starter according to claim 1, wherein said stop (68) is free in rotation with said drive shaft (13) when said pinion-holder (63) is in the position of rest.

9. Starter according to claim 8, wherein said device (92) for connection in rotation comprises two half shells (93, 94), each having an outer face in the form of a portion of a cone cooperating with a conical inner face with a complementary form of the stop ring (91).

10. Starter according to claim 1, wherein said half shells (93, 94) are situated spaced from one another when said pinion-holder (63) is in the position of rest.

11. Starter according to claim 1, wherein said stop (68) is integral in rotation with said drive shaft (13) irrespective of the position of said pinion-holder (63).

12. Starter according to claim 11, wherein said device (92) for connection in rotation comprises at least one flattened part (100) which cooperates with a flattened part (103) provided in said drive shaft (13), and at least one flattened part (101) which cooperates with a flattened part (104) of said stop ring (91).

13. Starter according to claim 12, wherein said drive shaft (13) comprises a number of flattened parts (103) which can cooperate with the at least one flattened part (100) of said device (92) for connection in rotation which is larger than the number of flattened parts (100) of said device (92) for connection in rotation which can cooperate with said drive shaft (13).

14. Starter according to claim 2, wherein said device (92) for connection in rotation comprises a ring (110) made of a deformable material fitted clamped between said drive shaft (13) and said stop ring (91), said deformable ring (110) cooperating with grooves (111) provided in an outer periphery of the drive shaft (13).

15. Starter according to claim 14, wherein a circlip (113) which forms a stop is also fitted in an annular groove (114) provided in an outer periphery of said drive shaft (13).

16. Starter according to claim 2, wherein said drive shaft (13) comprises a means (95) for axial retention of said device (92) for connection in rotation.

17. Starter according to claim 3, wherein said starter comprises a device (99) for axial retention of the stop ring cooperating with said device (92) for connection in rotation.

18. Starter according to claim 4, wherein said starter comprises a device (99) for axial retention of the stop ring cooperating with said device (92) for connection in rotation.

19. Starter according to claim 5, wherein said starter comprises a device (99) for axial retention of the stop ring cooperating with said device (92) for connection in rotation.
